(19) United States
(12) Patent Application Publication
(10) Pub. No.: US 2013/0084358 A1
(43) Pub. Date: Apr. 4, 2013

(54) Method To Reduce Biogenic Amine Content in Food

(71) Applicants: Jeppe Wegener Tams, Gentofte (DK); Anne Mette Bhatia Frederiksen, Copenhagen Oe (DK); Henrik Oestdal, Virum (DK); Thomas Vollmond, Dyssegaard (DK); Per Munk Nielsen, Hilleroed (DK)

(72) Inventors: Jeppe Wegener Tams, Gentofte (DK); Anne Mette Bhatia Frederiksen, Copenhagen Oe (DK); Henrik Oestdal, Virum (DK); Thomas Vollmond, Dyssegaard (DK); Per Munk Nielsen, Hilleroed (DK)

(73) Assignee: NOVOZYMES A/S, Bagsvaerd (DK)

(21) Appl. No.: 13/702,829

(22) PCT Filed: May 31, 2011
(86) PCT No.: PCT/EP2011/058934

§ 371 Date: Dec. 7, 2012

(30) Foreign Application Priority Data
Jun. 11, 2010 (EP) 10165685.8

(51) Int. Cl. C12H 1/00

(52) U.S. Cl. CPC C12H 1/003
USPC 426/12; 426/592

(57) ABSTRACT

This invention relates to a method of reducing biogenic amine content in a beverage by contacting the beverage and/or beverage intermediate with an enzyme having transglutaminase activity.

### FIELD OF THE INVENTION

This invention relates to a method of reducing the content of biogenic amines in food. More particularly, this invention relates to a method of reducing biogenic amines in low protein food, for example, beverages like wine and beer. Even more particularly, this invention relates to the use of enzymes having transglutaminase activity to reduce the content of biogenic amines in low protein food, for example, beverages like wine and beer.

### BACKGROUND OF THE INVENTION

Biogenic amines are a group of organic nitrogenous compounds. They are generally formed and degraded by the metabolisms of living organisms. They can be naturally present or formed by decarboxylation of aminoacids or by amination and transamination of aldehydes and ketones.

In low concentrations, biogenic amines, especially those produced endogenously in the body, are essential for many physiological functions, for example, regulation of body temperature, stomach volume, stomach pH, brain activity etc. However consumption of foods containing high concentrations of biogenic amines have been shown to cause some adverse effects such as headaches, hypo- or hypertension, nausea, cardiac palpitation and even mortality in severe cases.

When conditions that favor microbial or biochemical activity persist, biogenic amines are likely formed in food and beverages that contain proteins or free amino acids. Examples of such food and beverages include but not limited to fish, fish products, meat products (sausages), eggs, cheeses, fermented milk products, chocolate, nuts, fermented and fresh fruits, vegetables such as sauerkraut and soy bean products including soy sauce, beers and wines. Thus the presence and concentration of biogenic amines in food is thought to be related to spoilage and fermentation, particularly by microorganisms.

Beer and wine are known to contain many different biogenic amines in various amounts and compositions. Histamine, tyramine, putrescine, isopentylamine and beta-phenylethylamine are some common biogenic amines found in wine.

The human body has specific enzymes like, for example, diamine oxidases (DAO) and monoamine oxidases (MAO) to metabolize and thus detoxify the low quantities of biogenic amines in the food to physiologically less active degradation products. However, when foods with high concentration of biogenic amines are ingested, this detoxification system is unable to eliminate biogenic amines sufficiently. Moreover, in some people, where there is insufficient activity of these enzymes due to various factors like genetic makeup, diseases, effects of medicines etc, even low amounts of biogenic amines cannot be metabolized efficiently. If detoxification is inefficient, biogenic amines are readily absorbed by the gut, leading to toxic effects. Therefore biogenic amines are of concern in relation to food spoilage, food safety, and food intolerance and efforts have to be made to ensure their content in foods to be as low as possible.

Many countries are reviewing proposals for regulatory framework for capping the maximum limits of biogenic amines in food products. The European Union (EU) is similarly working on a regulatory framework for biogenic amines which intends to include biogenic amines under similar regulations as proposed for allergens.

Methods to reduce the biogenic amine content in food stuff are known, for example, amine oxidases have been used to enzymatically reduce the content of biogenic amines in food.

U.S. Pat. No. 4,725,540 discloses a process for preparing amine oxidase containing material and a process for metabolizing histamine in foodstuffs, yielding corresponding histamine free products in which the histamine had been metabolized forming not harmful metabolization products.

Punakivi et al., Talanta 68 (2006) 1040-1045 discloses a process for enzymatic determination of biogenic amines with transglutaminase.

However the need for more processes to reduce the biogenic amine content in food continues to exist.

### SUMMARY OF THE INVENTION

In one aspect, the invention relates to a method of reducing biogenic amine content in a beverage comprising contacting the beverage and/or beverage intermediate with a transglutaminase.

In another aspect, the invention relates to the use of transglutaminase for reducing biogenic amine content in beverage.

In one aspect, the transglutaminase is obtainable from Streptomyces.

In one aspect, the food is a beverage or a beverage intermediate.

In one aspect, the beverage is low in protein.

In one aspect, the beverage is wort.

In another aspect, the beverage is alcoholic.

In one aspect, the beverage is wine.

In another aspect, the beverage is beer.

In one aspect, the biogenic amine is selected from tyramine, histamine and combinations thereof.

In one aspect, the contacting is done in the presence of peptide bound glutamine.

In another aspect, the contacting is done in the absence of peptide bound glutamine.

In one aspect, at least 50% of the biogenic amine is reduced upon treatment with the enzyme.

In one aspect, the contacting with the enzyme is done at pH of 3.0 to 6.5.

### DETAILED DESCRIPTION OF THE INVENTION

The inventors have found a method of reducing the amount of biogenic amines in food, particularly beverages that contain low quantities of protein/amino acids. The inventors surprisingly found that treatment of beverages or beverage intermediates with an enzyme having transglutaminase activity can reduce the biogenic amine content in such materials and also products made by processing of such foods, intermediates or raw materials.

Thus in one aspect, the invention relates to a method of reducing biogenic amine content in a beverage comprising contacting the beverage and/or beverage intermediate with an enzyme having transglutaminase activity.

Biogenic amines are a group of organic, nitrogenous compounds. They are generally formed and degraded by the metabolisms of living organisms. They are usually formed by decarboxylation of aminoacids or by amination and transamination of aldehydes and ketones. They can be present endogenously (inside the organism) or naturally (outside the organism, de novo) or can be formed upon metabolism of food by microorganisms. Examples of biogenic amines include, but not limited to, histamine, tyramine, beta-phenylethylamine, tryptamine, putrescine, cadaverine, spermine, spermidine, butylamine, dimethylamine, ethanolamine, ethylamine, hexylamine, indole, isopropylamine, isopentylamine, methylamine, 2-methylbutylamine, morpholine, pentylamine, piperidine, propylamine, pyrrolidine, putrescine and serotonine.

The term food includes beverages, beverage intermediates and solid food material.

Beverages are known in the art. Examples of beverages include, but are not limited to, milk, juice, wine, beer, for example but not limited to, beer made from malted grains or un malted grains or mixtures thereof, ale, strong ale, bitter, stout, porter, lager, export beer, malt liquor, barley wine, happoushu, high-alcohol beer, low-alcohol beer, low-calorie beer or light beer. lemonade, wort, milk related products, for example, but not limited to cocoa milk, whole milk, full fatted milk, flavoured milk, homogenized milk, skimmed milk, reconstituted milk powder, condensed milk, whey, whey permeate, butter milk, fermented milk, yoghurt, curd.

The phrase “beverage intermediate” refers to a material formed during the process of manufacture of a beverage. Examples of beverage intermediates include but are not limited to wort, un-processed juice, un-processed beer, un-processed wine, un-processed milk, fermented cocoa beans. Sometimes, the beverage intermediate could itself be consumed and in such cases it can also be a “beverage”.

In one aspect, the beverage is low in protein. A beverage that is low in protein is a beverage that has less than 5%, such as less than 2%, such as less than 1%, such as less than 0.5%, such as less than 0.1%, such as less than 0.01%, such as less than 0.001% protein w/w. Examples of beverages that are low in protein include but not limited to, beer and wine.

In another aspect, the beverage is alcoholic. Alcoholic beverages are beverages containing ethanol. Common alcoholic beverages include beer, wine and spirits. Beer and wine are formed by the fermentation of sugar or starch containing material. Spirits, which have higher alcohol content compared to beer and wine, are produced by fermentation followed by distillation. Preferred alcoholic beverages are beer and wine. Alcoholic beverages also include beverages containing alcohol which are mixtures of the common alcoholic and/or non alcoholic beverages, for example, but not limited to, mixtures of beer and spirits or wine and spirits or spirits and juice.

In one aspect the beverage is wine. Wines and wine-making are known in the art. Winemaking, or vinification, is the process of producing wine, starting with selection of the grapes and ending with a bottled wine product. Winemaking involves several processes including, but are not limited to, selection of grapes and their varieties, their harvesting and de-stemming, primary crushing and fermentation, secondary fermentation, maturation, blending and fining, filtration, cold stabilization and bottling. In brief, a typical wine making process can be described as below: Grapes are selected and harvested manually or by using mechanical harvesters. The grapes are then generally crushed, de-stemmed and allowed for primary fermentation. During primary fermentation, yeast, that is normally already present on the grapes or is added externally as a culture, feed on the sugars in the must (fruit pulp) and multiply, producing carbon dioxide and alcohol. If desired, additional sugar is also added (chaptalization). During or after the process of alcohol fermentation, malolactic fermentation where malic acid is converted into lactic acid by bacteria may also take place. After primary fermentation, the wine product or crude wine is then made to undergo secondary fermentation and maturation process, which usually takes around 3-6 months or up to 18 months for long aging wines. During this stage, the wine is kept at anaerobic conditions or nearly anaerobic conditions to prevent oxidative deterioration. After the secondary fermentation, the wine is also racked to separate it from the lees. Racking is the process of siphoning the wine off the lees into a new, clean barrel or tank to allow clarification and aid stabilization. Lees refers to deposits of dead yeast or residual yeast and other particles that precipitate, or are carried by the action of “fining”, to the bottom of a vat of wine after fermentation and aging. The racking process is repeated several times during the aging of wine. During any time after maturation, the wine is also made to undergo the process of cold stabilization. During the cold stabilizing process, the temperature of the wine, is dropped to close to freezing for 1-2 weeks. This causes the tartrate crystals to separate from the wine and stick to the sides of the holding vessel. When the wine is drained from the vessels, the tartrate crystals are left behind and/or the wine is filtered to ensure their removal. During the protein stabilization process, unstable proteins are removed by adsorption onto fining agents like bentonite, preventing them from precipitating in the bottled wine. Subsequent to secondary fermentation, the wine is subjected to blending and fining. During blending, the wines from different batches and/or different grapes are mixed together to achieve a consistent taste. During fining, agents called fining agents are used to remove tannins, reduce astringency and remove microscopic particles that could cloud the wines. After blending and fining, the wine is treated with preservatives like sulphur dioxide and potassium sorbate and subjected to filtration. Filtration is the process by which the particulate matter from the wine is removed by passing the wine through a series of filters. Subsequent to filtration, the wine is sometimes sterile filtered through membranes of 0.65 or 0.45 micron before wine is bottled and marketed.

In wine, biogenic amines can possibly arise from the must, in which they are already present, or can be formed by the yeast from the natural flora, the added yeast, during alcoholic fermentation; or be formed by the action of bacteria involved in malolactic fermentation.

In another aspect, the beverage is beer. The process of beer-brewing is well known to the person skilled in the art. A conventional procedure may be outlined in the following way: The starting material is malted (i.e. dampened, germinated and subsequently dried) barley and/or unmalted adjuncts, called the grist. During the mashing, where the grist is grounded and mixed with water, heated and stirred, the carbohydrates are degraded to fermentable sugars by the aid of the enzymes naturally present in the malt. After mashing, it is necessary to separate the liquid extract (the wort) from the solids (spent grain particles and adjuncts) in order to get clear wort. This process is described as lautering. Prior to lautering, the mash temperature may be raised to about 75-78° C. (165-173° F.) (known as a mashout). Wort filtration is important because the solids are enriched in large amounts of protein, poorly modified starch, fatty material, silicates, and polyphenols (tannins) and proteins. The extract retained in the spent grain after collection of the first wort may also be washed out by adding hot water on top of the lauter cake. This process is called sparging. The hot water flows through the spent grain and dissolves the remaining extract. The diluted wort is called second wort and its extract decreases from the original gravity of the first wort down to 1-2%. After addition of hops, the wort is boiled. Hereby numerous substances including several proteins are denatured and a precipitation of polyphenols will take place. After cooling and removal of precipitates, the finished beer wort (a) is aerated and yeast is added. After a main fermentation, lasting typically 5-10 days, most of the yeast is removed and the so called green beer (b) is stored at a low temperature, typically at 0-5° C. for one to 12 weeks. During this period the remaining yeast will precipitate together with polyphenols. To remove the remaining excess polyphenols a filtration is performed. The fermented beer (c) may now be carbonized prior to bottling. Carbon dioxide not only contributes to the perceived “fullness” or “body” and as a flavor enhancer, it also acts as to enhance foaming potential and plays an important role in extending the shelf life of the product.

The term “beer” as used herein is intended to cover at least beer prepared from mashes prepared from un-malted cereals as well as all mashes prepared from malted cereals, and all mashes prepared from a mixture of malted and un-malted cereals. The term “beer” also covers beers prepared with adjuncts, and beers with all possible alcohol contents.

In one aspect the beverage intermediate is wort.

In another aspect the beverage intermediate is the mash used to make the wort.

In one aspect, the biogenic amine is tyramine.

Tyramine is a biogenic amine derived from the amino acid tyrosine. It is also alternatively known as 4-(2-aminoethyl)phenol or 4-Hydroxyphenethylamine.

In another aspect, the biogenic amine is histamine.

Histamine is a biogenic amine derived from the amino acid Histidine. It is alternatively known as 2-(1H-imidazol-4-yl)ethanamine.

In the context of the present invention, an enzyme having transglutaminase activity may be an enzyme which catalyzes the acyl transfer between the gamma-carboxylamide group of peptide-bound glutamine (acyl donor) and primary amines (acyl acceptor), e.g. peptide-bound lysine. Free acid amides and amino acids also react. Proteins and peptides may thus be cross linked in this way. Transglutaminase may also, e.g. if amines are absent, catalyze the deamination of glutamine residues in proteins with H2O as the acyl acceptor.

A transglutaminase according to the invention may also be referred to as, e.g., protein glutamine-gamma-glutamyl transferase, Factor XIIIa, fibrinoligase, fibrin stabilizing factor, glutaminylpeptide gamma-glutamyltransferase, polyamine transglutaminase, tissue transglutaminase, or R-glutaminyl-peptide:amine gamma-glutamyl transferase or TGase or even “meat glue”. The group of transglutaminases comprises but is not limited to the enzymes assigned to subclass EC 2.3.2.13. Transglutaminases (EC 2.3.2.13) are a family of enzymes that catalyze the formation of a covalent bond between a free amine group (e.g., protein- or peptide-bound lysine) and the gamma-carboxamid group of protein- or peptide-bound glutamine. The gamma-carboxymide groups of peptide-bound glutamine residues act as acyl donors, and the 6-amino-groups of protein- and peptide-bound lysine residues act as acceptors, to give intra- and inter-molecular N(6)-(5-glutamyl)lysine crosslinks. These enzymes usually require calcium as a co-factor.

The enzyme catalyzed reaction can be represented as follows:

Protein glutamine+alkylamine<=>protein N(5)-alkylglutamine+NH(3)

Transglutaminases can be obtained from many sources, including but not limited to, Phytophthora cactorum, Streptomyces lydicus, Streptomyces mobaraensis etc.

Enzymes having transglutaminase activity are also commercially available. Examples include, but not limited to, Activa® available from Ajinomoto [Ajinomoto CO. INC. Tokyo, Japan], Saprona TG® [available from, for example, Fermenta Pro food services, Bratislava, Slovakia].

A transglutaminase to be used according to the invention is preferably purified. The term “purified” as used herein covers enzyme protein preparations where the preparation has been enriched for the enzyme protein in question. Such enrichment could for instance be: the removal of the cells of the organism from which an enzyme protein was produced, the removal of non-protein material by a protein specific precipitation or the use of a chromatographic procedure where the enzyme protein in question is selectively adsorbed and eluted from a chromatographic matrix. The transglutaminase may have been purified to an extent so that only minor amounts of other proteins are present. The expression “other proteins” relate in particular to other enzymes. A transglutaminase to be used in the method of the invention may be “substantially pure”, i.e. substantially free from other components from the organism in which it was produced, which may either be a naturally occurring microorganism or a genetically modified host microorganism for recombinant production of the transglutaminase.

However, for the uses according to the invention, the transglutaminase need not be that pure. It may, e.g., include other enzymes.

In a preferred aspect, the transglutaminase to be used in the method of the invention has been purified to contain at least 20%, preferably at least 30%, at least 40% or at least 50%, (w/w) of transglutaminase out of total protein. The amount of transglutaminase may be calculated from an activity measurement of the preparation divided by the specific activity of the transglutaminase (activity/mg EP), or it may be quantified by SDS-PAGE or any other method known in the art. The amount of total protein may, e.g., be measured by amino acid analysis.

In one embodiment of the methods of the invention, the enzyme having transglutaminase activity is recombinantly produced. There are no limitations on the origin of the transglutaminase of the invention and/or for use according to the invention. Thus, the term transglutaminase includes not only natural or wild-type transglutaminase obtained from microorganisms of any genus, but also any mutants, variants, fragments etc. thereof exhibiting transglutaminase activity, as well as synthetic transglutaminases, such as shuffled transglutaminases, and consensus transglutaminases. Such genetically engineered transglutaminases can be prepared as is generally known in the art, e.g. by Site-directed Mutagenesis, by PCR (using a PCR fragment containing the desired mutation as one of the primers in the PCR reactions), or by Random Mutagenesis. The preparation of consensus proteins is described in e.g. EP 897985. Gene shuffling is generally described in e.g. WO 95/22625 and WO 96/00343. Recombination of transglutaminase genes can be made independently of the specific sequence of the parents by synthetic shuffling as described in Ness, J. E. et al, in Nature Biotechnology, Vol. 20 (12), pp. 1251 1255, 2002. Synthetic oligonucleotides degenerated in their DNA sequence to provide the possibility of all amino acids found in the set of parent transglutaminases are designed and the genes assembled according to the reference. The shuffling can be carried out for the full length sequence or for only part of the se-quence and then later combined with the rest of the gene to give a full length sequence.

The enzyme may, e.g., be obtained from a strain of Agaricus, e.g. A. bisporus; Ascovaginospora; Aspergillus, e.g. A. niger, A. awamori, A. foetidus, A. japonicus, A. oryzae; Chaetomium; Chaetotomastia; Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer; Sclerotinia, e.g. S. libertiana; Trichophyton, e.g. T. rubrum; Whetzelinia, e.g. W. sclerotiorum; Bacillus, e.g. B. megaterium, B. subtilis, B. pumilus, B. stearothermophilus, B. thuringiensis; Chryseobacterium; Citrobacter, e.g. C. freundii; Enterobacter, e.g. E. aerogenes, E. cloacae Edwardsiella, E. tarda; Erwinia, e.g. E. herbicola; Escherichia, e.g. E. coli; Klebsiella, e.g. K. pneumoniae; Miriococcum; Myrothesium; Mucor; Neurospora, e.g. N. crassa; Phytophthora, e.g. P. cactorum; Proteus, e.g. P. vulgaris; Providencia, e.g. P. stuartii; Pycnoporus, e.g. Pycnoporus cinnabarinus, Pycnoporus sanguineus; Salmonella, e.g. S. typhimurium; Serratia, e.g. S. liquefasciens, S. marcescens; Shigella, e.g. S. flexneri; Streptomyces, e.g. S. antibioticus, S. castaneoglobisporus, S. lydicus, S. mobaraensis, S. violeceoruber; Streptoverticilium, e.g. S. mobaraensis; Trametes; Trichoderma, e.g. T. reesei, T. viride; Yersinia, e.g. Y. enterocolitica.

The enzyme having transglutaminase activity may be used alone or preferably in the form of an enzyme composition. Such enzyme compositions are known to a person skilled in the art. Enzyme composition may also contain other stabilizers that help stabilize the enzyme. The compositions of the invention may be in any form suited for the use in question, e.g. in the form of a dry powder or granulate, in particular a non-dusting granulate, a liquid, in particular a stabilized liquid, an immobilized form or a protected enzyme. Granulates may be produced, e.g. as disclosed in U.S. Pat. No. 4,106,991 and U.S. Pat. No. 4,661,452 (both to Novo Industri A/S), and may optionally be coated by methods known in the art. Liquid enzyme preparations may, for instance, be stabilized by adding nutritionally acceptable stabilizers such as a sugar, a sugar alcohol or another polyol, lactic acid or another organic acid according to established methods. Protected enzymes may be prepared according to the method disclosed in EP 238,216.

A preferred enzyme having transglutaminase activity is a transglutaminase obtainable from Streptomyces. Another preferred enzyme having transglutaminase activity is a transglutaminase obtainable from Streptomyces mobaraensis. Another preferred enzyme having transglutaminase activity is a transglutaminase obtainable from Streptomyces lydicus. Another preferred enzyme having transglutaminase activity is Activa®. Another preferred enzyme having transglutaminase activity is a calcium independent enzyme having transglutaminase activity. Another preferred enzyme having transglutaminase activity is an enzyme with cysteine as the active center. Examples of such enzymes include but not limited to Activa®.

The term “obtainable from” as used herein in connection with a given source shall mean that the polypeptide encoded by the nucleic acid sequence is produced by the source or by a recombinant cell (also called a host cell) in which the nucleic acid sequence from the source is present. In a preferred embodiment, the polypeptide is secreted extra-cellularly. Depending upon the host employed in a recombinant production procedure, the transglutaminases of the present invention may be glycosylated or may be non-glycosylated. In addition, the transglutaminases of the invention may also include an initial modified methionine residue, in some cases as a result of host-mediated processes.

The host cells may be a unicellular microorganism, e.g., a prokaryote, or a non-unicellular microorganism, e.g., a eukaryote.

Useful host cells are bacterial cells such as gram positive bacteria including, but not limited to, a Bacillus cell, or a Streptomyces cell, or cells of lactic acid bacteria; or gram negative bacteria such as E. coli and Pseudomonas sp. Lactic acid bacteria include, but are not limited to, species of the genera Lactococcus, Lactobacillus, Leuconostoc, Streptococcus, Pediococcus, and Enterococcus.

Other host cells can be fungal cells (including the phyla Ascomycota, Basidiomycota, Chytridiomycota, and Zygomycota (as defined by Hawksworth et al., In, Ainsworth and Bisby's Dictionary of The Fungi, 8th edition, 1995, CAB International, University Press, Cambridge, UK) as well as the Oomycota (as cited in Hawksworth et al., 1995, supra, page 171) and all mitosporic fungi (Hawksworth et al., 1995, supra).

In one aspect, the fungal host cell is a yeast cell. “Yeast” as used herein includes ascosporogenous yeast (Endomycetales), basidiosporogenous yeast, and yeast belonging to the Fungi Imperfecti (Blastomycetes). Since the classification of yeast may change in the future, for the purposes of this invention, yeast shall be defined as described in Biology and Activities of Yeast (Skinner, F. A., Passmore, S. M., and Davenport, R. R., eds, Soc. App. Bacteriol. Symposium Series No. 9, 1980). The yeast host cell may be a Candida, Hansenula, Kluyveromyces, Pichia, Saccharomyces, Schizosaccharomyces, or Yarrowia cell.

The fungal host cell may be a filamentous fungal cell. “Filamentous fungi” include all filamentous forms of the subdivision Eumycota and Oomycota (as defined by Hawksworth et al., 1995, supra). The filamentous fungi are characterized by a mycelial wall composed of chitin, cellulose, glucan, chitosan, mannan, and other complex polysaccharides. Vegetative growth is by hyphal elongation and carbon catabolism is obligately aerobic. In contrast, vegetative growth by yeasts such as Saccharomyces cerevisiae is by budding of a unicellular thallus and carbon catabolism may be fermentative.

Examples of filamentous fungal host cells are cells of species of, but not limited to, Acremonium, Aspergillus, Fusarium, Humicola, Mucor, Myceliophthora, Neurospora, Penicillium, Thielavia, Tolypocladium, or Trichoderma.

In the production methods of the present invention, the cells are cultivated in a nutrient medium suitable for production of the transglutaminase using methods known in the art. For example, the cell may be cultivated by shake flask cultivation, small-scale or large-scale fermentation (including continuous, batch, fed-batch, or solid state fermentations) in laboratory or industrial fermentors performed in a suitable medium and under conditions allowing the polypeptide to be expressed and/or isolated. The cultivation takes place in a suitable nutrient medium comprising carbon and nitrogen sources and inorganic salts, using procedures known in the art. Suitable media are available from commercial suppliers or may be prepared according to published compositions (e.g., in catalogues of the American Type Culture Collection). If the transglutaminase is secreted into the nutrient medium, the same can be recovered directly from the medium. If the transglutaminase is not secreted, it can be recovered from cell lysates.

The resulting enzyme having transglutaminase activity may be recovered by methods known in the art. For example, the enzyme may be recovered from the nutrient medium by conventional procedures including, but not limited to, centrifugation, filtration, extraction, spray-drying, evaporation, or precipitation.

The enzyme having transglutaminase activity of the present invention may be purified by a variety of procedures known in the art including, but not limited to, chromatography (e.g., ion exchange, affinity, hydrophobic, chromatofocusing, and size exclusion), electrophoretic procedures (e.g., preparative isoelectric focusing), differential solubility (e.g., ammonium sulfate precipitation), SDS-PAGE, or extraction (see, e.g., Protein Purification, J.-C. Janson and Lars Ryden, editors, VCH Publishers, New York, 1989).

The term “contacting” is the process of bringing the beverage or the beverage intermediate and enzyme in touch or immediate proximity with each other. Many methods of contacting the beverage with the enzyme are known in the art. The enzymes, for example, can be added to the beverage or food stuff, or vice-versa. The enzymes can also be in immobilized form and contacted with the beverage/food stuff.

In one aspect, the enzyme is added to the mash at the time of mashing during brewing. In another aspect, the enzyme is added to the wort at the time of lautering. In yet another aspect, the enzyme is added to the mash at the time of mashing off. In another aspect, the enzyme is added to the beer prior to bottling.

In one aspect, the enzyme is added to the must during vinification. In another aspect, the enzyme is added during fermentation. In another aspect, the enzyme is added during malolactic fermentation. In another aspect, the enzyme is added during racking.

In one aspect, the contacting is done in the presence of peptide bound glutamine.

The term “peptide bound glutamine” refers to peptides or proteins or mixtures thereof containing glutamine residue(s) bounded on one or either side by other amino acid or chemical residue(s). The peptides are at least 2 amino acid residues long and may be natural or synthetic and optionally contain other non-natural side group(s) or terminal groups. An example of a peptide bound glutamine is the peptide z-Gln-Gly-OH, also called N-benzyloxycarbonylglutamyl-L-Glycine, commercially available from Sigma-Aldrich® (Sigma-Aldrich, Missouri, USA). Preferred peptide bound glutamines are the peptide bound glutamines obtainable from food sources and other nutritionally acceptable sources, for e.g. but not limited to soy, caseinate, gluten or gelatin.

In another aspect, the contacting is done in the absence of peptide bound glutamine.

In one aspect, by practicing the method of the invention, at least 50% of the biogenic amine present in a beverage or beverage intermediate or food is reduced. The reduction is calculated as a percentage of the biogenic amine present in a sample before and after contacting with the enzyme. In another aspect, at least 40%, such as at least 45%, such as at least 50%, such as at least 55%, such as at least 60%, such as at least 65%, such as at least 70%, such as at least 75%, such as at least 80%, such as at least 81%, such as at least 82%, such as at least 83%, such as at least 84%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% of the biogenic amine present in a beverage or beverage intermediate or food is reduced.

In one aspect, by practicing the method of the invention, at least 50% of the histamine present in a beverage or beverage intermediate or food is reduced. The reduction is calculated as a percentage of the histamine present in a sample before and after contacting with the enzyme. In another aspect, at least 40%, such as at least 45%, such as at least 50%, such as at least 55%, such as at least 60%, such as at least 65%, such as at least 70%, such as at least 75%, such as at least 80%, such as at least 81%, such as at least 82%, such as at least 83%, such as at least 84%, such as at least 85%, such as at least 86%, such as at least 87%, such as at least 88%, such as at least 89%, such as at least 90%, such as at least 91%, such as at least 92%, such as at least 93%, such as at least 94%, such as at least 95%, such as at least 96%, such as at least 97%, such as at least 98%, such as at least 99% of the histamine present in a beverage or beverage intermediate or food is reduced.

There are various methods available to detect biogenic amine content in a food sample. These methods are generally known in the art. These include, but not limited to, chromatographic methods such as gas, liquid, high performance liquid chromatography, paper, thin layer, paper and capillary electrophoresis, other methods like radioimmunoassay or enzyme linked immunosorbent assay. Enzymatic methods are also available to determine the biogenic amine content in food stuff. These methods use enzymes like amine oxidases to convert biogenic amines into their corresponding aldehydes along with release of hydrogen peroxide and ammonia. Hydrogen peroxide and ammonia can then be detected by colorimetric methods.

A preferred method of detecting biogenic amine content according to this invention is a chromatographic method. Such a method is described in example 1.

The amount of enzyme having transglutaminase activity to be used will generally depend on the specific requirements and on the specific enzyme. The amount of transglutaminase addition preferably is sufficient to generate the desired reduction of biogenic amines within a specified time. Typically, a transglutaminase addition in the range from about 0.1 mg to about 1000 mg enzyme protein (EP) per liter of substrate (i.e. beverage or beverage intermediate) is sufficient, particularly from about 1 mg to about 500 mg enzyme protein (EP) per liter of substrate, particularly from about 10 mg to about 500 mg enzyme protein (EP) per liter of substrate, and more particularly from about 50 mg to about 200 mg enzyme protein (EP) per liter of substrate. It is within the general knowledge of the skilled person to adjust the amount of specific enzyme needed for reduction of biogenic amines.

Alternatively the enzyme can also be added in terms of the units of enzyme activity. The activity of the transglutaminase is measured in terms of TGH units. One TGHU (TransGlutaminase Hydroxamate Unit) is the amount of enzyme that produces 1 pmole Hydroxamate per minute using Z-Gln-Gly and Hydroxylamine as substrates at 37° C., pH 6. Typically the enzyme activity added would range from about 2.0 TGHU to about 25000 TGHU per liter of substrate, such as about 20 TGHU to about 25000 TGHU per liter of substrate, such as about 200 TGHU to about 12000 TGHU per litre of substrate, such as about 1000 TGHU to about 5000 TGHU per liter of substrate.

The contacting should be done for a suitable period of time (incubation time) to allow the reduction of the biogenic amines in a sample. Generally, the incubation time is selected based on the nature of the beverage. For example in case of beer or wort the incubation may be in the order of a few hours or days while in the case of wine, the incubation may be in the order of many days to weeks. Moreover the incubation time is also dependent on the concentration of biogenic amines in the original sample, the concentration of enzyme used etc. It is within the general knowledge of the skilled person to adjust the incubation time needed for reduction of biogenic amines.

The incubation temperature will generally depend on the transglutaminase used and is typically selected according to the optimal reaction temperature for the transglutaminase. The skilled person will know how to identify the optimal temperature for an enzyme. The suitable temperature also depends on the nature of the beverage/food stuff and the stage of production at which the enzyme is added. For example, for beer, a suitable temperature will be in the range from about 40° C. to about 80° C., preferably in the range of 45° C. to 75° C., more preferably in the range of 50° C. to 70° C., even more preferably in the range of 50° C. to 65° C. For wine a suitable temperature would depend on the nature of the wine and age of the wine. For example for white wines, the suitable temperatures range from about 15° C. to about 25° C., preferably in the range of about 18° C. to about 22° C. For red wines, the suitable temperatures range from about 20° C. to about 35° C., preferably between 25° C. to 30° C.

The contacting should also be done at an optimum pH at which the transglutaminase is active. Generally the pH should be in the range of 3.0 to 9.0, preferably in the range of 3.0 to 7.5, even more preferably in the range of 3.0 to 7.0, most preferably in the range of 3.0 to 6.5. A person skilled in the art would be able to adjust the pH levels to obtain optimum enzyme activity. A person skilled in the art would also be able to select a suitable enzyme based on the properties of the beverage. The choice of a suitable pH also depends on the nature of the beverage/food stuff and the stage of production at which the enzyme is added.

### EXAMPLES

### Materials and Methods

The following describes a chromatographic method to simultaneously detect tyramine and histamine in a sample.

Chromatographic experiments were performed using a DIONEX Summit HPLC with a fluorescent spectrophotometric detector (excitation: 340 nm, emission: 460 nm). Separation was carried at 40° C. at a flow rate of 1 mg/min using a C18 110A column from Phenomenx (particle size 3 μm) preceded with a guard-column packed with C18. The following eluents were applied: A (0.56% trimethylamine buffer, pH 7.5, ionic strength 20 mM) and B (90% acetonitrile and 10% Milli-Q water).

Acetonitrile is commercially available from Merck and trimethylamine, tyramine and histamine from Sigma-Aldrich.

The following gradient was applied:

| Time | | |
|---|---|---|
| (min) | % A | % B |
| 0-5 | 100 | 0 |
| 5 | 60 | 30 |
| 5-20 | 2% decrease | 2% increase |
| | per min | per min |
| 20 | 30 | 60 |
| 20-25 | 0 | 100 |

An individual standard solution of the two amines (0.5 mM tyramine and 0.5 mM histamine) was prepared in aqueous solution and stored in darkness at 4° C. The derivatization process was carried out as follows: 10 mg/mL OPA reagent (Agilent technologies, P.N. 5061-3335) and borate buffer (0.4 N in Milli-Q water) were diluted 4 times with Milli-Q water. 10 μL borate buffer, 2 μL OPA and 2 uL sample were mixed with 100 μL Milli-Q water followed by injection to the column. Histamine has a retention time of 9.8 min whereas tyramine has a retention time of 12.7 min. The two peaks were well separated from the amino acids present in the sample.

### Example 1

Use of transglutaminase (TGase), diamine oxidase (DAO) and monoamine oxidase (MAO) to reduce the biogenic amine content in a sample.

The removal of histamine and tyramine by transglutaminase, diamine oxidase and monoamine oxidase were evaluated in buffer systems, wort and beer.

Transglutaminase from Streptomyces mobaraensis was obtained as disclosed in EP2175737.

DAO (D7876), MAO (A M7316), histamine, tyramine and z-Gln-Gly were obtained from Sigma Aldrich.

42 μL wort (typical 100% malt wort, 12° F.) was mixed with the following according to the below:
7 μL stock consisting of 10 mM histamine and 10 mM tyramine
50 μL 10 mM z-Gln-Gly or 50 μL 10 mM phosphate buffer pH 5.8
1.05 μL TGase stock solution consisting of 9.5 mg EP/mL

HPLC measurements were conducted according to Example 1 after 1 hour incubation at 37° C. under shaking (900 rpm).

| | | | | % area of | % area of |
|---|---|---|---|---|---|
| | | Temp. | | histamine | tyramine |
| Sample | pH | (° C.) | Enzyme | peak | peak |
| Wort + histamine + | 5.8 | 37 | — | 100 | 100 |
| tyramine + z-Gln- | | | | | |
| Gly | | | | | |
| Wort + histamine + | 5.8 | 37 | TGase | 55.7 | 91.2 |
| tyramine | | | | | |
| Wort + histamine + | 5.8 | 37 | TGase | 0 | 13.3 |
| tyramine +z -Gln- | | | | | |
| Gly | | | | | |

The above table demonstrates 44.3 and 8.8% removal of histamine and tyramine respectively in the presence of biogenic amine with TGase, and 100 and 86.7% removal of histamine and tyramine respectively in the presence of biogenic amine together with TGase and peptide bound glutamine (z-Gln-Gly).

### MAO and DAO:

In the buffer system a final mixture of 0.156 mM histamine, 0.156 mM tyramine with or without 0.5 mg EP DAO/mL or 0.25 mg EP MAO/mL were incubated for 1 hour at pH 4.2, 5.8, 6.5, 7.2 (37° C.) or for 1 hour at 37, 50, 60 and 70° C. (pH 7.2) under shaking (900 rpm) according to the below table. In a wort and beer system 7 μL stock solution consisting of 10 mM histamine and 10 mM tyramine and 83 μL wort were mixed with:
10 μL 10 mg/mL DAO or
1 μL 0.05 mg/mL MAO+9 μL 10 mM phosphate buffer or
10 μL 10 mM phosphate buffer according to below table.

HPLC measurements were conducted according to Example 1 after 1 hours incubation at different temperatures from 37° C. to 70° C. [under shaking (900 rpm).

| | | | | % area of | % area of |
|---|---|---|---|---|---|
| | | Temp. | | histamine | tyramine |
| Sample | pH | (° C.) | Enzyme | peak | peak |
| Buffer | 7.2 | 37 | — | 100 | 100 |
| Buffer | 4.2 | 37 | DAO | 49.7 | 84.5 |
| Buffer | 5.8 | 37 | DAO | 39.3 | 88.6 |
| Buffer | 6.5 | 37 | DAO | 32.0 | 87.2 |
| Buffer | 7.2 | 37 | DAO | 24.3 | 95.7 |
| Buffer | 7.2 | 37 | — | 100 | 100 |
| Buffer | 7.2 | 37 | DAO | 24.3 | 95.7 |
| Buffer | 7.2 | 50 | DAO | 0.1 | 92.0 |
| Buffer | 7.2 | 60 | DAO | 42.6 | 99.1 |
| Buffer | 7.2 | 70 | DAO | 85.8 | 94.6 |
| Buffer | 7.2 | 37 | — | 100 | 100 |
| Buffer | 4.2 | 37 | MAO | 70.5 | 59.7 |
| Buffer | 5.8 | 37 | MAO | 78.9 | 56.1 |
| Buffer | 6.5 | 37 | MAO | 69.2 | 42.7 |
| Buffer | 7.2 | 37 | MAO | 82.8 | 28.0 |
| Buffer | 7.2 | 37 | — | 100 | 100 |
| Buffer | 7.2 | 37 | MAO | 82.8 | 28.0 |
| Buffer | 7.2 | 50 | MAO | ND | 33.9 |
| Buffer | 7.2 | 60 | MAO | 66.4 | 58.9 |
| Buffer | 7.2 | 70 | MAO | 71.1 | 67.3 |
| Wort | 5.8 | 50 | — | 10.3 | 0 |
| Wort + histamine | 5.8 | 50 | — | 100 | 100 |
| and tyramine | | | | | |
| Wort + histamine | 5.8 | 50 | DAO | 20.1 | 101 |
| and tyramine | | | | | |
| Wort + histamine | 5.8 | 37 | MAO | 98.4 | 73.6 |
| and tyramine | | | | | |
| Beer | 4.2 | 37 | — | 0 | 0 |
| Beer + histamine | 4.2 | 37 | — | 100 | 100 |
| and tyramine | | | | | |
| Beer +histamine | 4.2 | 37 | DAO | 86.1 | 98.3 |
| and tyramine | | | | | |
| Beer + histamine | 4.2 | 37 | MAO | 89.4 | 93.5 |
| and tyramine | | | | | |

The above results demonstrates that DAO reduces completely the level of histamine in a buffer systemin a buffer system (50° C., pH 7.2) and MAO to reduce the level of tyramine in a buffer system from 100 to 28% in a buffer system (37° C., pH 7.2). DAO was capable of reducing histamine from 100 to 20% in wort (50° C., pH 5.8) and from 100 to 86% in beer (37° C., pH 4.2). MAO was not very efficient in reducing tyramine in a wort and beer system.

In summary, transglutaminase was superior than MAO and DAO in removing histamine and tyramine at the same time in a wort system.

### Example 2

Amino acid analysis of the samples treated with transglutaminase, MAO and DAO was done to see if there is any major change in the amino acid composition of the wort samples.

Chromatographic experiments were conducted similar to the method described above, but with the following exceptions.

The following eluents were applied: A (0.56% trimethylamine buffer, pH 7.5, ionic strength 20 mM) and B (45% acetonitrile, 45% methanol and 10% Milli-Q water). The following gradient was applied:

| Time | | |
|---|---|---|
| (min) | % A | % B |
| 0 | 88 | 12 |
| 12 | 88 | 12 |
| 50 | 60 | 40 |
| 59 | 39 | 61 |
| 60 | 18 | 82 |
| 60.5 | 0 | 100 |
| 62.5 | 0 | 100 |
| 63 | 88 | 12 |
| 67 | 88 | 12 |

A standard solution consisting of 2.5 mM of each amino acid including Norvalin (internal standard) is prepared in 0.1 N HCl. The standard curve is mad by the following dilutions of the above solution: 2, 8, 16, 32, 64 and 128× with 0.1 N HCl.

In each HPLC vial 700 μL Milli-Q water, 100 μL internal standard, 200 μL sample was added. The derivatization process was carried out as follows: 10 mg/mL OPA reagent (Agilent technologies, P.N. 5061-3335, FMOC reagent (Agilent technologies, P.N. 5061-3337) and borate buffer (0.4 N in Milli-Q water) were diluted 4 times with Milli-Q water. 2 μL sample from the above explained mix in the HPLC vial, 10 μL borate buffer, 2 μL OPA reagent, 2 μL FMOC reagent, 10 μL borate buffer and 100 μL Milli-Q water was added injected to the column.

The amino acid profile in % relative area of the wort samples treated with transglutaminase, MAO and DAO described in example 2 was determined:

| | | | Wort + |
|---|---|---|---|
| | Wort + | Wort + | histamine + |
| | histamine + | histamine + | tyramine + |
| | tyramine + | tyramine + | TGase + |
| Amino acid | z-Gln-Gly | TGase | z-Gln-gly |
| Aspartic acid | 1.1 | 1.15 | 1.16 |
| Glutamic acid | 1.21 | 1.63 | 1.57 |
| Aspargine | 1.95 | 2.03 | 2.08 |
| Serine | 3.43 | 3.55 | 3.61 |
| Glutamine | 7.39 | 7.17 | 7.47 |
| Histidine | 0.4 | 0.4 | 0.42 |
| Arginine | 6.2 | 6.39 | 6.53 |
| Glycine | 3.7 | 3.83 | 3.89 |
| Threonine | 1.75 | 1.82 | 1.87 |
| Alanine | 6.31 | 6.56 | 6.64 |
| Tyrosine | 2.35 | 2.42 | 2.6 |
| Valine | 4.69 | 5.83 | 5.02 |
| Methionine | 1.45 | 1.51 | 1.53 |
| Norvaline | 0.32 | 0.33 | 0.33 |
| Tryptophan | 0.89 | 0.93 | 0.94 |
| Phenylalanine | 3.84 | 3.99 | 4.08 |
| Isoleucine | 2.64 | 2.76 | 2.8 |
| Leucine | 8.21 | 8.52 | 8.65 |
| Lysine | 2.51 | 2.33 | 0.68 |
| Total | 57.93 | 62.9 | 61.87 |

From the table above, it is clear that the total amino acid content is similar across samples and only lysine decreased by the joint action of TGase and z-Gly-gln, but not TGase alone.

| | | | Wort + | Wort + |
|---|---|---|---|---|
| | | Wort + | histamine | histamine |
| | | histamine | and | and |
| | | and | tyramine + | tyramine + |
| Amino acid | Wort | tyramine | DAO | MAO |
| Aspartic acid | 1.13 | 1.09 | 1.14 | 1.11 |
| Glutamic acid | 1.24 | 1.2 | 1.64 | 1.22 |
| Aspargine | 1.96 | 1.91 | 1.99 | 1.93 |
| Serine | 3.34 | 3.27 | 4.45 | 3.34 |
| Glutamine | 7.17 | 7.04 | 8.01 | 7.18 |
| Histidine | 0.42 | 0.39 | 0.4 | 0.39 |
| Arginine | 5.92 | 5.85 | 6.03 | 5.9 |
| Glycine | 3.39 | 3.41 | 4.71 | 3.52 |
| Threonine | 1.85 | 1.76 | 2.08 | 1.78 |
| Alanine | 6.06 | 5.97 | 7.59 | 6.12 |
| Tyrosine | 2.34 | 2.28 | 2.35 | 2.3 |
| Valine | 4.76 | 4.55 | 5.39 | 4.65 |
| Methionine | 1.4 | 1.39 | 1.55 | 1.41 |
| Norvaline | 0.3 | 0.3 | 0.28 | 0.3 |
| Tryptophan | 0.89 | 0.87 | 0.84 | 0.87 |
| Phenylalanine | 3.81 | 3.71 | 3.76 | 3.76 |
| Isoleucine | 2.66 | 2.58 | 3 | 2.63 |
| Leucine | 7.84 | 7.79 | 8.35 | 7.9 |
| Lysine | 2.45 | 2.4 | 2.47 | 2.41 |
| Total | 58.91 | 57.77 | 66.04 | 58.73 |

From the table above, it is clear that the total amino acid content was unaffected by the action of MAO and DAO.

1. A method of reducing biogenic amine content in a beverage comprising contacting the beverage and/or beverage intermediate with an enzyme having transglutaminase activity.

2. The method according to claim 1 wherein the enzyme having transglutaminase activity is obtainable from Streptomyces.

3. The method according to claim 1 wherein the biogenic amine is selected from tyramine, histamine and combinations thereof.

4. The method according to claim 1 wherein the contacting is done in the presence of peptide bound glutamine.

5. The method according to claim 1 wherein the contacting is done in the absence of peptide bound glutamine.

6. The method according to claim 1 wherein at least 50% of the biogenic amine is reduced.

7. The method according to claim 1 wherein the beverage has a protein content less than 5% (w/w).

8. The method according to claim 1 wherein the beverage is wort.

9. The method according to claim 1 wherein the beverage is alcoholic.

10. The method according to claim 8 wherein the alcoholic beverage is beer.

11. The method according to claim 8 wherein the alcoholic beverage is wine.

12. The method according to claim 1 wherein the contacting is done at pH 3.0-6.5.

13. The method according to claim 1 wherein concentration of the enzyme having transglutaminase activity used is about 0.1 mg to about 1000 mg enzyme protein (EP) per liter of beverage or beverage intermediate.

14. (canceled)

15. A beverage having low content of biogenic amines obtained by a method of claim 1.
